(19) United States
(12) Patent Application Publication
(10) Pub. No.: US 2013/0061119 A1
(43) Pub. Date: Mar. 7, 2013

(54) Method, System and Non-Transitory Program Storage Device for Creation of a Signature

(71) Applicant: Christopher B. Jackson, West Vancouver (CA)

(72) Inventor: Christopher B. Jackson, West Vancouver (CA)

(21) Appl. No.: 13/225,535

(22) Filed: Sep. 5, 2011

(51) Int. Cl. G06F 17/00

(52) U.S. Cl. 715/206

(57) ABSTRACT

A method, system and non-transitory program storage device for creation of a signature on a client device comprises displaying a preview area comprising a layout being selectable by a user. The layout comprises a plurality of portions being arranged to form a signature. The portions are operable for displaying images, video, text, logos, hyperlinks and Really Simple Syndication (RSS). A displayed a data entry area is operable for accepting user inputs for presentation in the portions. Accepted user inputs are previewed in the preview area while accepting user inputs. The signature comprising portions with user inputs is saved. The saved signature is accessible to the user for attachment to electronic documents.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to user interface systems. More particularly, the invention relates to a user interface system for creating signatures associated with email.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

A multiplicity of methods for creating email signatures is available. As an example, textual email signatures may be created via globally networked email providers. As another example, email applications and software operating locally may also support creation of textual email signatures.

Graphical email signatures may be created using word processor type applications, wherein a user may enter text, images, hyperlinks and other associated information.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example signature, in accordance with an embodiment of the present invention;

FIGS. 2A-C illustrate an example signature, in accordance with an embodiment of the present invention;

FIG. 3A illustrates an example signature interface for creating/modifying an example signature as described with reference to FIG. 2A, in accordance with an embodiment of the present invention;

FIG. 3B illustrates an example signature interface for creating/modifying an example signature as described with reference to FIG. 2C, in accordance with an embodiment of the present invention;

FIG. 4 illustrates an example method for creation of a signature, in accordance with an embodiment of the present invention;

FIG. 5 illustrates a block diagram depicting a conventional client/server communication system, which may be associated with the present invention; and

FIG. 6 illustrates a computing device that, when appropriately configured or designed, may serve as a computing device for which the present invention may be embodied.

Unless otherwise indicated illustrations in the figures are not necessarily drawn to scale.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention will be described which provide means and method for creating digital signatures.

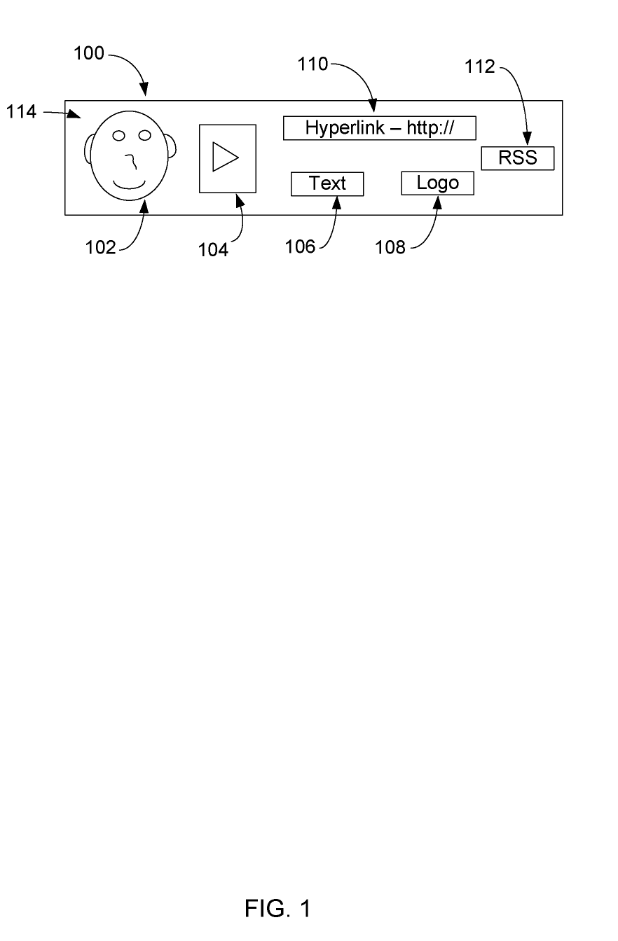

FIG. 1 illustrates an example signature, in accordance with an embodiment of the present invention.

A signature 100 includes an image 102, a video 104, a text portion 106, a logo portion 108, a hyperlink portion 110 and an RSS portion 112.

Signature 100 provides a signature. As a non-limiting example, signature 100 may be used as a signature associated with an email.

Image 102 provides an image. As a non-limiting example, image 102 may present a picture for viewing.

Video 104 provides a video for viewing. As a non-limiting example, video may be performed via user selection. As non-limiting examples, fast forward, reverse, stop and pause may be performed for video 104.

Logo portion 108 may present a logo for viewing. Non-limiting examples for logo portion 108 include corporate logos, non-profit logos and governmental logos.

Hyperlink portion 110 may present for viewing an item referenced via a hypertext link. Furthermore, as a non-limiting example, referenced item may be provided via a communication network.

RSS portion 112 provides an information content feed. As a non-limiting example, RSS portion 112 may be performed via Really Simple Syndication (RSS).

A background presentation 114 may be provided for presenting a background for viewing. Non-limiting examples for background include any known color and/or color combination.

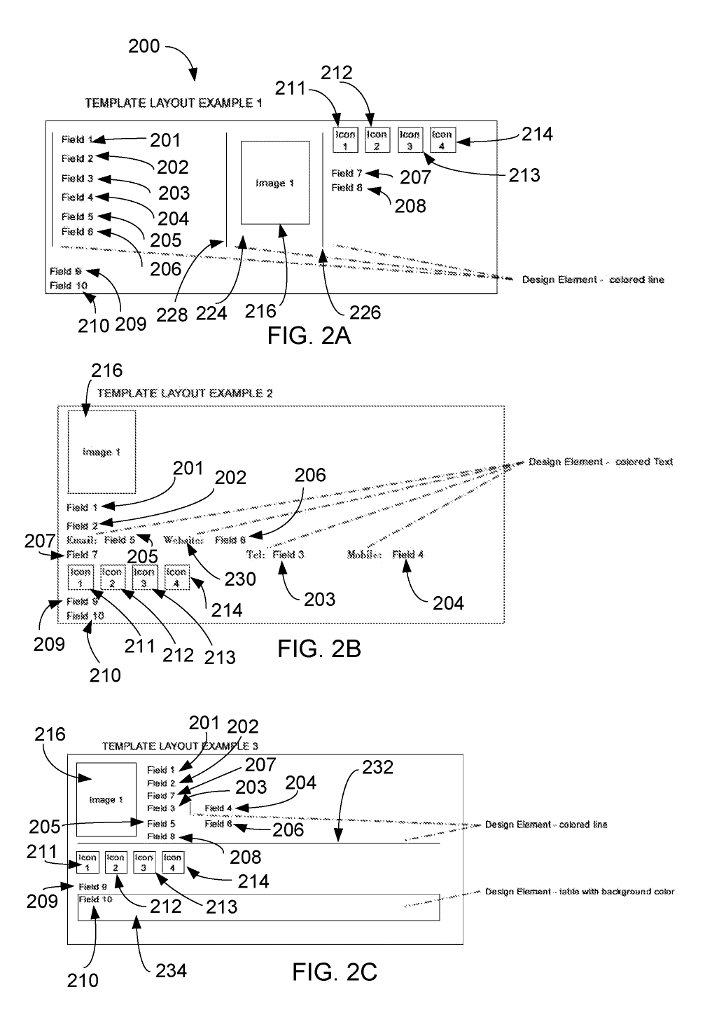

FIG. 2A illustrates an example signature, in accordance with an embodiment of the present invention.

A signature 200 includes a field 201, a field 202, a field 203, a field 204, a field 205, a field 206, a field 207, a field 208, a field 209, a field 210, an icon field 211, an icon field 212, an icon field 213, an icon field 214 and an image field 216.

Signature 200 provides a presentation of information for viewing by a user (not shown).

Fields 201, 202, 203, 204, 205, 206, 207, 208, 209 and 210 provide a presentation of information for viewing. As a non-limiting example, fields 201, 202, 203, 204, 205, 206, 207, 208, 209 and 210 may present textual information.

Icon fields 211, 212, 213 and 214 provide a presentation of information associated with an icon for viewing. As a non-limiting example, icon fields 211, 212, 213 and 214 may present an image associated with a company logo.

Image field 216 provides presentation of information associated with an image for viewing. As a non-limiting example, image field 216 may present a picture.

Signature 200 may be segmented into a multiplicity of sub-presentation displays of information with a sampling denoted as a sub-presentation display 224. Furthermore, sub-presentation displays of information may be segmented via a multiplicity of design elements with a sampling denoted as a design element 226 and a design element 228. As an example, sub-presentation display 224 may be segmented via design element 226 and design element 228. As a non-limiting example, design element 226 and design element 228 may be configured as a line of any know color.

FIG. 2B illustrates an example signature, in accordance with an embodiment of the present invention.

A multiplicity of design elements may be provided with a sampling denoted as a design element 230.

As a non-limiting example, design element 230 may provide description information associated with field 206. As a non-limiting example, design element 230 may be presented as textual information of any known color or combination of colors. Furthermore, as a non-limiting example, design element 230 may be presented for describing design element 230 as website information. Non-limiting examples for design elements include email address, website link information, telephone number and mobile telephone number.

Fields 201, 202, 203, 204, 205, 206, 207, 208, 209 and 210, icon fields 211, 212, 213 and 214, and image field 216 are configured for different locations for FIG. 2B than as illustrated for FIG. 2A.

FIG. 2C illustrates an example signature, in accordance with an embodiment of the present invention.

A multiplicity of design elements may be provided with a sampling denoted as a design element 232 and a design element 234.

Design element 232 may be configured as a line of any known color or combination of colors.

Design element 234 may be configured as a table with a background of any known color or combination of colors.

Fields 201, 202, 203, 204, 205, 206, 207, 208, 209 and 210, icon fields 211, 212, 213 and 214, and image field 216 are configured for different locations for FIG. 2C than as illustrated for FIGS. 2A-B.

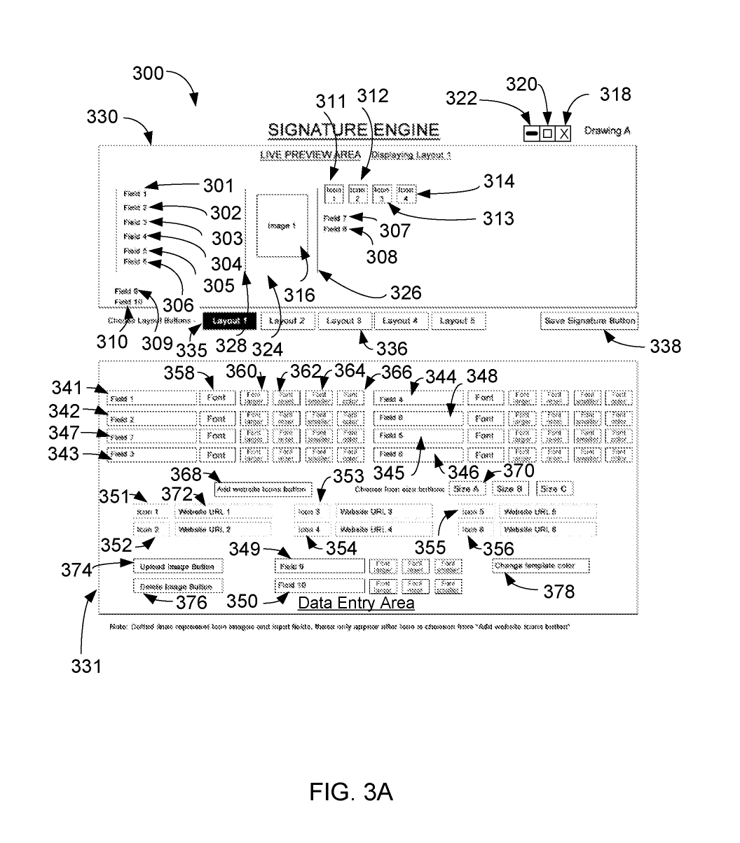

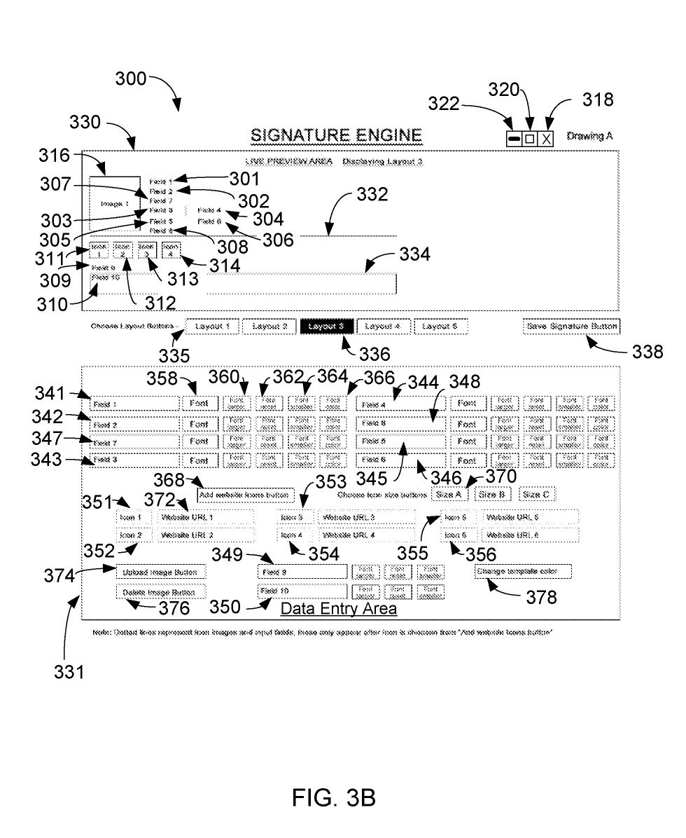

FIG. 3A illustrates an example signature interface for creating/modifying an example signature as described with reference to FIG. 2A, in accordance with an embodiment of the present invention.

A signature interface system 300 includes a preview area 330, a data entry area 331, an exit selection 318, a maximize selection 320 and a minimize selection 322.

Preview area 330 provides a means for presenting a view of a signature.

Data entry area 331 provides a means for receiving information associated with a signature.

Exit selection 318 provides a means for terminating display of signature interface system 300.

Maximize selection 320 provides a means for maximizing the display of information as presented by signature interface system 300.

Minimize selection 322 provides a means for minimizing the display of information as presented by signature interface system 300.

Preview area 330 includes a field 301, a field 302, a field 303, a field 304, a field 305, a field 306, a field 307, a field 308, a field 309, a field 310, an icon field 311, an icon field 312, an icon field 313, an icon field 314, an image field 316, a multiplicity of layout selections with a sampling denoted as a layout selection 335 and a layout selection 336 and a save signature selection 338.

Preview area 330 provides a display of information for viewing by a user (not shown).

Fields 301, 302, 303, 304, 305, 306, 307, 308, 309 and 310 provide for presentation of information. As a non-limiting example, fields 301, 302, 303, 304, 305, 306, 307, 308, 309 and 310 may present textual information.

Icon fields 311, 312, 313 and 314 provide for presentation of information associated with an icon. As a non-limiting example, icon fields 311, 312, 313 and 314 may present an image associated with a company logo.

Image field 316 provides presentation of information associated with an image. As a non-limiting example, image field 316 may present a picture.

Preview area 330 may be segmented into a multiplicity of sub-presentation displays of information with a sampling denoted as a sub-presentation display 324. Furthermore, sub-presentation displays of information may be segmented via a multiplicity of design elements with a sampling denoted as a design element 326 and a design element 328. As an example, sub-presentation display 324 may be segmented via design element 326 and design element 328. As a non-limiting example, design element 326 and design element 328 may be configured as a line of any know color.

Layout selection 335 and layout selection 336 provide a means for selecting a layout for viewing via preview area 330.

Save signature selection 338 provides a means for saving a signature to a memory or storage device.

Data entry area 331 includes a field 341, a field 342, a field 343, a field 344, a field 345, a field 346, a field 347, a field 348, a field 349, a field 350, an icon field 351, an icon field 352, an icon field 353, an icon field 354, an icon field 355, an icon field 356 a multiplicity of font selections with a sampling denoted as a font selection 358, a multiplicity of font increase selections with a sampling denoted as a font increase selection 360, a multiplicity of font reset selections with a sampling denoted as a font reset selection 362, a multiplicity of font decrease selections with a sampling denoted as a font decrease selection 364, a multiplicity of font color selections with a sampling denoted as a font color selection 366, an add website icon selection 368, a multiplicity of icon size buttons with a sampling denoted as an icon size button 370, a multiplicity of link fields with a sampling denoted as a link field 372, an image upload selection 374, a delete image selection 376 and a modify template color selection 378.

Data entry area 331 provides a means for viewing and entering information for a signature by a user (not shown).

Fields 341, 342, 343, 344, 345, 346, 347, 348, 349 and 350 provide entry of information. As a non-limiting example, fields 341, 342, 343, 344, 345, 346, 347, 348, 349 and 350 may receive textual information.

Icon fields 351, 352, 353, 354, 355 and 356 provide entry of information associated with an icon. As a non-limiting example, icon fields 351, 352, 353, 354, 355 and 356 may receive an image associated with a company logo.

Font selection 358 provides a means for selection of a font.

Font increase selection 360 provides a means for increasing the size of a font.

Font reset selection 362 provides a means for resetting a font configuration.

Font decrease selection 364 provides a means for decreasing the size of a font.

Font color selection 366 provides a means for selecting the color of a font.

Add website icon selection 368 provides a means for adding a website icon.

Icon size button 370 provides a means for selecting the size of an icon.

Link field 372 provides a means for configuring a website link associated with an icon.

Image upload selection 374 provides a means for selecting and uploading an image for presentation.

Delete image selection 376 provides a means for deleting an image.

Modify template color selection 378 provides a means for modifying the color of a template.

Signature interface system 300 may be used for creating personalized signatures (e.g. signature 100 (FIG. 1) and signature 200 (FIGS. 2A-C)). As a non-limiting example, signatures may be used for communication associated with email. Non-limiting examples of entities which may be associated with a signature include images, photos, website link information and textual information.

Signatures may be formatted for communication via email.

Signatures may be configured in a format for saving for later retrieval and use. As a non-limiting example, format for saving may be HyperText Markup Language (HTML).

Signatures may be inserted into and communicated via email messages.

Signatures may be used for local email applications. Furthermore, signatures may be used for global network email applications.

Signatures may be retrieved and modified. Non-limiting examples for modifications include text modification, image modification and website link modification. Furthermore, after retrieval and modification signature may be saved for later retrieval and use.

Signatures may be created via a multiplicity of templates. Furthermore, templates may support images, special fonts, logos, website link information and website linked images.

Preview area 330 provides a means for a user to preview a signature as it is created/modified.

Signatures may be created with embedded images stored and hosted via signature interface system 300. Furthermore, a signature may support a multiplicity of embedded images.

Signature interface system 300 provides a means for a user to create, edit and personalize signatures. User may enter information associated with a signature and then select from a multiplicity of signature templates. Furthermore, signatures may be previewed prior to selection for use.

Signatures may be created via a globally network interface or via a local interface.

Text may be entered for a signature. Non-limiting examples for configuring text features include fonts, colors and sizes.

Tables may be created. Furthermore, any known color or combinations of colors may be supported for table background.

Globally networked icon images may be associated with signatures. As a non-limiting example, icons associated with social networking sites may be included. As a non-limiting example, zodiac icons may be included. Furthermore, icons may be included via linking or by reference.

Sizes of images and icons may be configurable via a multiplicity of predetermined configuration sizes. Furthermore, size selection may be performed via a single selection action. Non-limiting examples for configuration sizes include small, medium and large.

As a non-limiting example, personal quotes, messages and legal disclaimers may be associated with signatures.

Icons comprising functional text may be associated with a signature. When an icon is selected, a function is activated such as, but not limited to, contacting the owner of the signature. In a non-limiting example a text messaging function works by user entering their mobile number with area code into a text field then selecting from a drop down list of cell phone carriers (ex. 310-555-5555, T-Mobile). A database on a server has all of the mobile carriers email to text formats—(ex. T-Mobile: 10-digit phone number]@tmomail.net—Example: 310-555-5555@tmomail.net). The signature will then display a TEXT ME icon. When the TEXT ME icon is clicked by a recipient, an Internet browser is opened and a website is then called up, ex. www.sigwich.com/textme. This page has a form with text input fields: Name, Email, Telephone, Message and a send button. The recipient fills out the form and hits send which sends the message via email to the mobile phone.

Status information and updates from externally linked global network sites may be included in signature. Non-limiting examples of information associated with externally linked global network sites include weather forecast, daily horoscope, daily joke, news, news headlines and RSS feed.

Globally networked access to signature interface system 300 may be gained via a user account with associated user account information (e.g. user identification and password). Signatures may be saved and retrieved for later editing via global network access.

Images associated with signatures may be cropped. Furthermore, images may be automatically cropped based upon a criteria selected by user. Furthermore, image orientation may be selected. Non-limiting examples for selected image orientation include corner type, vertical and horizontal. Furthermore, image may be further processed based upon square, round and rounded corners. Furthermore, round may be configurable based upon small, medium and large.

Text fields may be automatically linked with external globally networked information. Furthermore, an email address may be automatically linked.

Furthermore, icon images (e.g. social network icon images) may automatically be associated with a signature. Furthermore, a multiplicity of preconfigured icon images may be provided for associating with a signature.

Signature interface system 300 detects and adjusts preview information provided by preview area 330 as entered into data entry area 331.

Signature may be communicated to external entities via signature interface system 300. As a non-limiting example, signature may be communicated to external entities via a popup text input selection.

Non-limiting examples of platforms for developing and operation of signature interface system 300 include PHP, Java, AJAX, HTML and C++. Furthermore, databases may be used for development of signature interface system 300. As a non-limiting example, MYSQL database may be used for operation.

Signature interface system 300 may be supported via personal computers, global networks (e.g. Internet) and/or mobile devices.

Implementation of signature interface system 300 may be performed via a series of steps using a multiplicity of information presentations.

Information may be provided to signature interface via an external source. As a non-limiting example, information may be provided via an Application Interface (API). Furthermore, information may be obtained externally from an existing signature.

Phone calls may be initiated via phone numbers associated with signature.

Selection associated with signature may update a globally networked external entity. As a non-limiting example, a selection may provide an incremental count for the number of selections performed.

Textual input field associated with signature may update a globally networked external entity.

Video may be associated with signature.

Affiliate codes may be associated with signature for tracking sales and referral information.

Signature interface system 300 may be used for creating signatures for instant messaging and text messaging.

Signature interface system 300 may be used as a mobile application.

Signature interface system 300 may be used as an application for global network applications.

Signature interface system 300 may incorporate email tracking applications.

Signature interface system 300 may incorporate instant messaging and text messaging tracking applications.

Signature interface system 300 may be used for creating digital signatures (e.g. for legal documents).

Signature interface system 300 may be used for global network identity verification.

Signature interface system 300 may be used for global network identification purposes.

Signature interface system 300 may be incorporated for use associated with national and international registries for identification and security purposes.

Signature interface system 300 may be used for applications associated with a central collection or repository of signature cards. Furthermore, back-links may be provided.

Signature interface system 300 may incorporate social networking interface mechanisms (e.g. likes and tweets).

Signature interface system 300 may be used for traditional print/paper associated signatures.

FIG. 3B illustrates an example signature interface for creating/modifying an example signature as described with reference to FIG. 2C, in accordance with an embodiment of the present invention.

A multiplicity of design elements may be provided with a sampling denoted as a design element 332 and a design element 334.

Design element 332 may be configured as a line of any known color or combination of colors.

Design element 334 may be configured as a table with a background of any known color or combination of colors.

Fields 301, 302, 303, 304, 305, 306, 307, 308, 309 and 310, icon fields 311, 312, 313 and 314, and image field 316 are configured for different locations for FIG. 3B than as illustrated for FIG. 3A.

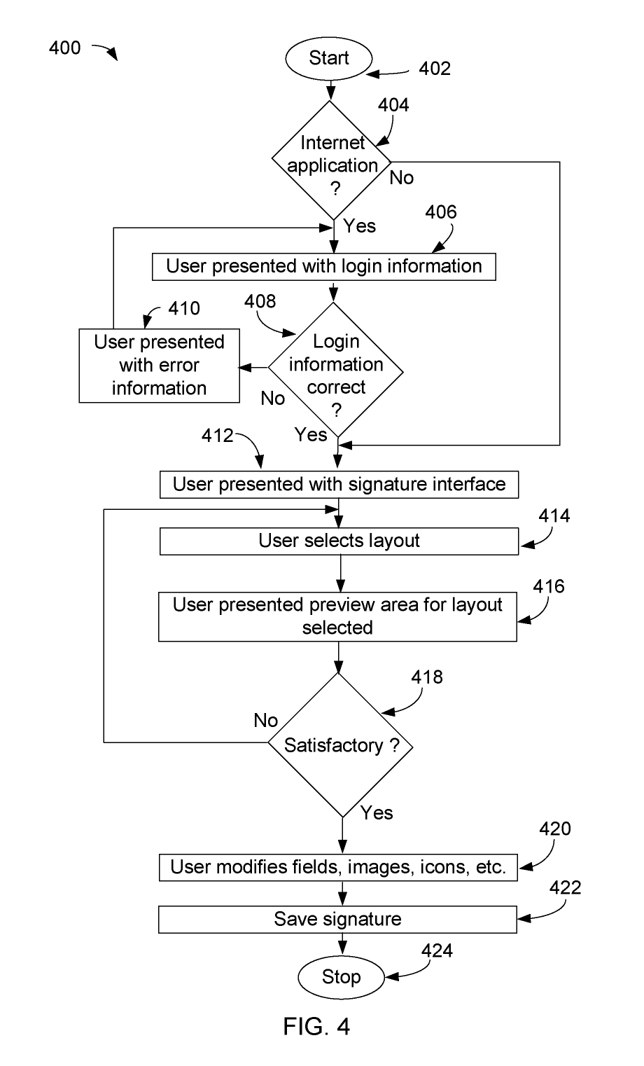

FIG. 4 illustrates an example method for creation of a signature, in accordance with an embodiment of the present invention.

A method 400 initiates in a step 402.

In a step 404, it may be determined as to whether a signature is being created via a global network or locally.

For a determination in step 404 for creating signature via a global network, user is presented in a step 406 with login information for gaining access in order to perform efforts associated with a signature.

In a step 408, it may be determined as to whether a user presented correct information for gaining access for performing efforts associated with a signature.

For a determination of user not providing correct information in step 408, user is presented with error information in a step 410.

For a determination of access not provided via global network in step 404 and for user providing correct information in step 408, user is presented with a signature interface in a step 412 (e.g. signature interface system 300 (FIGS. 3A-B).

Signature interface system 300 of FIGS. 3A-B is presented to user for efforts associated with a signature.

In a step 414, user selects a layout associated with a signature (e.g. layout selection 335 (FIGS. 3A-B) or layout selection 336 (FIGS. 3A-B)).

As a non-limiting example, user may select layout selection 335 as illustrated in FIG. 3A in order to perform efforts associated with creating a signature as described with reference to FIG. 2A. As another non-limiting example, user may select layout selection 336 as illustrated in FIG. 3B in order to perform efforts associated with creating a signature as described with reference to FIG. 2C.

In a step 416, user is presented with a preview area (e.g. preview area 330 (FIGS. 3A-B) associated with a signature.

As a non-limiting example, for a user selecting layout selection 335 as illustrated in FIG. 3A, user is presented with preview area 330 as presented in FIG. 3A. As a non-limiting example, for a user selecting layout selection 336 as illustrated in FIG. 3B, user is presented with preview area 330 as presented in FIG. 3B.

In a step 418, a determination may be performed as to whether user finds the selected layout satisfactory.

For a determination of an unsatisfactory layout in step 418, execution of method 400 transitions to step 414.

For a determination of a satisfactory layout in step 418, user may, in a step 420, modify fields, images, icons, etc. associated with signature interface system 300 (FIGS. 3A-B). Furthermore, after entry and modification of fields, images, icons, a user may select a different signature layout for viewing and use.

Non-limiting examples of information entered include name, company name, telephone numbers, address, email address, website address, tagline, legal disclaimer and other textual information. Furthermore, entered information may be modified with respect to font, font color and font sizes. Furthermore, icons and/or icon links may be selected for insertion into signature. Furthermore, sizes of icons may be modified by selecting icon size selections.

Images, photos, logos, etc. may be uploaded and associated with signature. Following upload, images, etc. may be custom cropped by user. Furthermore, a multiplicity of image corner types may be selected. Non-limiting examples for image corner types include square and rounded. Furthermore, the orientation of the uploaded image may be selected. Non-limiting examples for orientation include horizontal and vertical.

In a step 422, user may save signature for later retrieval and use.

As an example, user may enter textual information into field 341 (FIG. 3A). Furthermore, following entry of text information into field 341, text information would be presented to user in field 301 (FIG. 3A). Furthermore, textual information entered into field 341 would be presented in field 201 (FIG. 2A) of signature 200.

As another example, user may select to modify the font of a text by selecting font selection 358 (FIG. 3A). After modifying text font, text with new font is presented via field 301 (FIG. 3A). Furthermore, text associated with field 201 (FIG. 2A) would also be modified accordingly. Furthermore, other properties of text may be modified via font increase selection 360 (FIG. 3A), font reset selection 362 (FIG. 3A), font decrease selection 364 (FIG. 3A) and font color selection 366 (FIG. 3A).

As another example, a user may select to upload an image by selecting image upload selection 374 (FIG. 3A) and selecting an image to upload. Following selection and upload of image, image may be presented in image field 316 (FIG. 3A). Furthermore, uploaded image may be presented in image field 216 (FIG. 2A). Furthermore, uploaded image may be deleted via selection of delete image selection 376 (FIG. 3A).

As another example, colors associated with signature may be modified via selection of modify template color selection 378 (FIG. 3A).

After modifications have been performed, signature may be saved by selection of save signature selection 338 (FIG. 3A).

In a step 424, method 400 terminates execution.

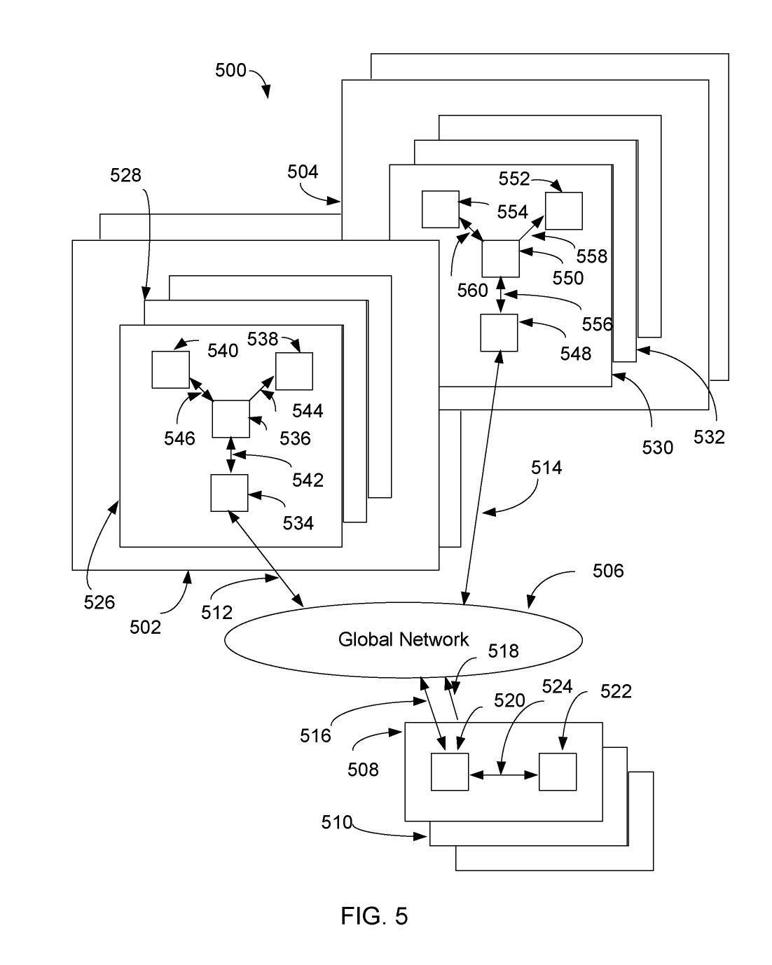

FIG. 5 illustrates a block diagram depicting a conventional client/server communication system, which may be associated with the present invention.

A communication system 500 includes a multiplicity of networked regions with a sampling of regions denoted as a network region 502 and a network region 504, a global network 506 and a multiplicity of servers with a sampling of servers denoted as a server device 508 and a server device 510.

Network region 502 and network region 504 may operate to represent a network contained within a geographical area or region. Non-limiting examples of representations for the geographical areas for the networked regions may include postal zip codes, telephone area codes, states, counties, cities and countries. Elements within network region 502 and 504 may operate to communicate with external elements within other networked regions or within elements contained within the same network region.

In some implementations, global network 506 may operate as the Internet. It will be understood by those skilled in the art that communication system 500 may take many different forms. Non-limiting examples of forms for communication system 500 include local area networks (LANs), wide area networks (WANs), wired telephone networks, cellular telephone networks or any other network supporting data communication between respective entities via hardwired or wireless communication networks. Global network 506 may operate to transfer information between the various networked elements.

Server device 508 and server device 510 may operate to execute software instructions, store information, support database operations and communicate with other networked elements. Non-limiting examples of software and scripting languages which may be executed on server device 508 and server device 510 include C, C++, C# and Java.

Network region 502 may operate to communicate bi-directionally with global network 506 via a communication channel 512. Network region 504 may operate to communicate bi-directionally with global network 506 via a communication channel 514. Server device 508 may operate to communicate bi-directionally with global network 506 via a communication channel 516. Server device 510 may operate to communicate bi-directionally with global network 506 via a communication channel 518. Network region 502 and 504, global network 506 and server devices 508 and 510 may operate to communicate bi-directionally and communicate with other networked device located within communication system 500.

Server device 508 includes a networking device 520 and a server 522. Networking device 520 may operate to communicate bi-directionally with global network 506 via communication channel 516 and with server 522 via a communication channel 524. Server 522 may operate to execute software instructions and store information.

Network region 502 includes a multiplicity of clients with a sampling denoted as a client 526 and a client 528. Client 526 includes a networking device 534, a processor 536, a GUI 538 and an interface device 540. Non-limiting examples of devices for GUI 538 include monitors, televisions, cellular telephones, smartphones and PDAs (Personal Digital Assistants). Non-limiting examples of interface device 540 include pointing device, mouse, trackball, scanner and printer. Networking device 534 may communicate bi-directionally with global network 506 via communication channel 512 and with processor 536 via a communication channel 542. GUI 538 may receive information from processor 536 via a communication channel 544 for presentation to a user for viewing. Interface device 540 may operate to send control information to processor 536 and to receive information from processor 536 via a communication channel 546. Network region 504 includes a multiplicity of clients with a sampling denoted as a client 530 and a client 532. Client 530 includes a networking device 548, a processor 550, a GUI 552 and an interface device 554. Non-limiting examples of devices for GUI 538 include monitors, televisions, cellular telephones, smartphones and PDAs (Personal Digital Assistants). Non-limiting examples of interface device 540 include pointing devices, mousse, trackballs, scanners and printers. Networking device 548 may communicate bi-directionally with global network 506 via communication channel 514 and with processor 550 via a communication channel 556. GUI 552 may receive information from processor 550 via a communication channel 558 for presentation to a user for viewing. Interface device 554 may operate to send control information to processor 550 and to receive information from processor 550 via a communication channel 560.

For example, consider the case where a user interfacing with client 526 may want to execute a networked application. A user may enter the IP (Internet Protocol) address for the networked application using interface device 540. The IP address information may be communicated to processor 536 via communication channel 546. Processor 536 may then communicate the IP address information to networking device 534 via communication channel 542. Networking device 534 may then communicate the IP address information to global network 506 via communication channel 512. Global network 506 may then communicate the IP address information to networking device 520 of server device 508 via communication channel 516. Networking device 520 may then communicate the IP address information to server 522 via communication channel 524. Server 522 may receive the IP address information and after processing the IP address information may communicate return information to networking device 520 via communication channel 524. Networking device 520 may communicate the return information to global network 506 via communication channel 516. Global network 506 may communicate the return information to networking device 534 via communication channel 512. Networking device 534 may communicate the return information to processor 536 via communication channel 542. Processor 536 may communicate the return information to GUI 538 via communication channel 544. User may then view the return information on GUI 538.

As an example, GUI 538 may be used for presenting signature interface system 300 (FIGS. 3A-B) for viewing. Furthermore, interface device 540 may be used for providing information to data entry area 331 (FIGS. 3A-B). Furthermore, server 522 may be used for storing and retrieving instructional code for signature interface system 300 (FIGS. 3A-B). Furthermore, server 522 may be used for storing and retrieving information entered via data entry area 331 (FIGS. 3A-B). Furthermore, server 522 may be used for storing and retrieving signatures (e.g. signature 100 (FIG. 1), signature 200 (FIGS. 2A-C).

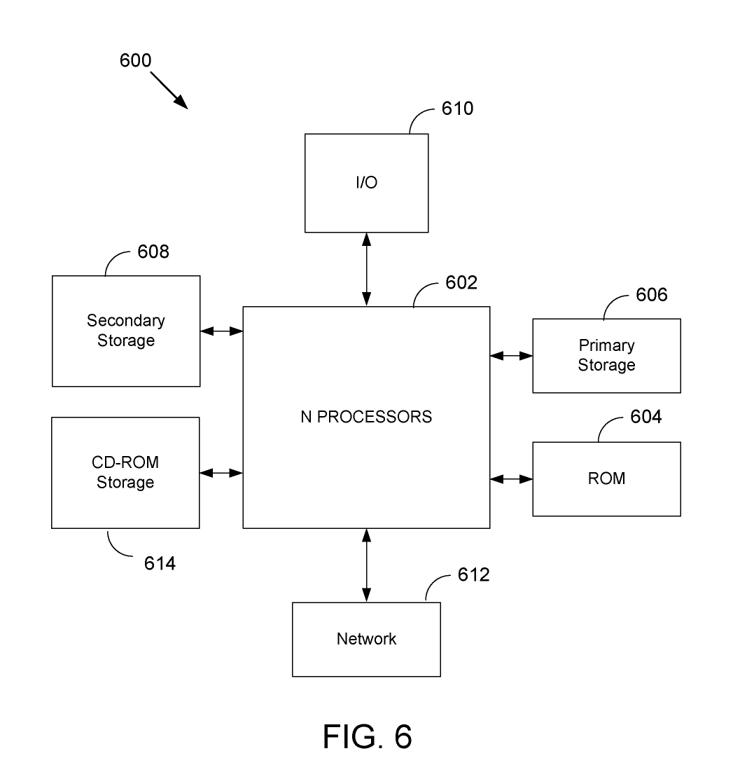

FIG. 6 illustrates a computing device that, when appropriately configured or designed, may serve as a computing device for which the present invention may be embodied.

A computing device 600 includes a quantity of processors 602 (also referred to as central processing units, or CPUs) that may be coupled to storage devices including a primary storage 606 (typically a random access memory, or RAM), a primary storage 604 (typically a read only memory, or ROM). CPU 602 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 604 acts to transfer data and instructions uni-directionally to the CPU and primary storage 606 is used typically to transfer data and instructions in a bi-directional manner. The primary storage devices discussed previously may include any suitable computer-readable media such as those described above. A mass storage device 608 may also be coupled bi-directionally to CPU 602 and provides additional data storage capacity and may include any of the computer-readable media described above. Mass storage device 608 may be used to store programs, data and the like and is typically a secondary storage medium such as a hard disk. It will be appreciated that the information retained within mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 may also be coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or internet network using an external connection shown generally as a network 612, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: server devices 508 (FIG. 5), 510 (FIG. 5), and global network 506 as described with reference to FIG. 5 and portions of example method as described with reference to FIG. 4.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of signature interface system according to the present invention will be apparent to those skilled in the art. The invention has been described above by way of illustration, and the specific embodiments disclosed are not intended to limit the invention to the particular forms disclosed. For example, the particular implementation of the applications associated with the signature creation may vary depending upon the particular type of client device used. The client devices described in the foregoing were directed to computer based implementations; however, similar techniques associated with smartphone device implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method for creation of a signature on a client device, the client device comprising at least one processor coupled to memory programmed for performing the method comprising the steps of:
displaying a preview area comprising a layout being selectable by a user, said layout comprising a plurality of portions being arranged to form a signature, said portions being operable for displaying images, video, text, logos, hyperlinks and Really Simple Syndication (RSS);
displaying a data entry area being operable for accepting user inputs for presentation in said portions;
previewing said accepted user inputs in said preview area while accepting user inputs; and
saving said signature comprising portions with user inputs, said saved signature being accessible to the user for attachment to electronic documents.

2. The method as recited in claim 1, in which said layout further comprises a background color being selectable by the user.

3. The method as recited in claim 1, in which said portions further comprise icon fields.

4. The method as recited in claim 3, in which a size of icons is selectable by the user.

5. The method as recited in claim 3, in which at least one of said icon fields is operable for presenting an icon comprising a hyperlink.

6. The method as recited in claim 3, in which at least one of said icon fields is operable for presenting an icon comprising functional text.

7. The method as recited in claim 1, in which said layout further comprises design elements.

8. The method as recited in claim 7, in which said design elements segment said layout.

9. The method as recited in claim 7, in which said design elements describe an associated user input.

10. The method as recited in claim 1, in which said portions further comprise text fields.

11. The method as recited in claim 10, in which a font, a size and a color of text is selectable by the user.

12. A signature interface system comprising:
means being operable for presenting a view of a signature comprising a selectable layout, said layout comprising a plurality of portions and design elements being arranged to form a signature, said portions being operable for displaying images, video, text, logos, hyperlinks and Really Simple Syndication (RSS);
means being operable for receiving inputs for presentation in said portions while communicating said inputs to said presenting means for presentation, said inputs comprising a background color for said signature, icons comprising a selected size and hyperlinks, icons comprising a selected size and functional text, text comprising a selected font size and color, and uploaded images and video; and
means for saving said signature comprising portions with inputs, said saved signature being accessible for attachment to electronic documents.

13. A non-transitory program storage device readable by a machine tangibly embodying a program of instructions executable by the machine to perform a method for creation of a signature on a client device, comprising:
computer code for displaying a preview area comprising a layout being selectable by a user, said layout comprising a plurality of portions being arranged to form a signature, said portions being operable for displaying images, video, text, logos, hyperlinks and Really Simple Syndication (RSS);
computer code for displaying a data entry area being operable for accepting user inputs for presentation in said portions;
computer code for previewing said accepted user inputs in said preview area while accepting user inputs; and
computer code for saving said signature comprising portions with user inputs, said saved signature being accessible to the user for attachment to electronic documents.

14. The non-transitory program storage device as recited in claim 13, in which said layout further comprises a background color being selectable by the user.

15. The non-transitory program storage device as recited in claim 13, in which said portions further comprise icon fields.

16. The non-transitory program storage device as recited in claim 15, in which a size of icons is selectable by the user.

17. The non-transitory program storage device as recited in claim 15, in which at least one of said icon fields is operable for presenting an icon comprising a hyperlink.

18. The non-transitory program storage device as recited in claim 15, in which at least one of said icon fields is operable for presenting an icon comprising functional text.

19. The non-transitory program storage device as recited in claim 13, in which said layout further comprises design elements for segmenting said layout and for describing an associated user input.

20. The non-transitory program storage device as recited in claim 13, in which a font, a size and a color of text is selectable by the user.
